(19) United States
(12) Patent Application Publication
(10) Pub. No.: US 2025/0035291 A1
(43) Pub. Date: Jan. 30, 2025

(54) FOUR-IN-ONE DOWN LAMP WITH ROTATABLE MOUNTING DISK STRUCTURE AND IMPLEMENTATION METHOD THEREOF

(71) Applicant: Hengdian Group Tospo Lighting Co., Ltd., Jinhua (CN)

(72) Inventors: Liang CHEN, Jinhua (CN); Tong CAO, Jinhua (CN); Tao LI, Jinhua (CN); Jinli SHAN, Jinhua (CN); Heng LI, Jinhua (CN); Jinghang ZHOU, Jinhua (CN); Miao HAN, Jinhua (CN)

(21) Appl. No.: 18/545,237

(22) Filed: Dec. 19, 2023

(30) Foreign Application Priority Data
Jul. 26, 2023 (CN) 202310929132.1

(51) Int. Cl. F21V 21/04; F21S 8/02; F21V 3/00

(52) U.S. Cl. CPC F21V 21/04; F21S 8/02; F21V 3/00

(57) ABSTRACT

A four-in-one down lamp with a rotatable mounting disk structure includes a lamp body and a mounting disk; the lamp body includes an outer shell; a concave cavity is arranged on an upper surface of the outer shell; a side wall of the concave cavity is connected to two symmetrically arranged fastening edges; two steps corresponding to the fastening edges are connected to a periphery of the mounting disk; and the mounting disk is further formed with screw holes and positioning slots which are configured to be connected to a mounting member. Further disclosed is an implementation method of a four-in-one down lamp with a rotatable mounting disk structure. The mounting disk and the lamp body are connected to each other through cooperation between the fastening edges and the steps. The four-in-one down lamp is mounted rotatably, so that elastic sheets are eliminated, and spaces in a driving box and for wiring are not occupied. Different mounting members are connected through screws on the mounting disk to satisfy four common mounting scenarios of a North American down lamp, so that the stocking pressure of a client is greatly reduced, and the application range is large.

### CROSS-REFERENCE TO RELATED APPLICATION

This application claims foreign priority benefits under 35 U.S.C. § 119 from Chinese Patent Application No. 202310929132.1, filed Jul. 26, 2023, the content of which is hereby incorporated by reference in its entirety.

### TECHNICAL FIELD

The present disclosure belongs to the technical field of down lamps, and particularly, to a four-in-one down lamp with a rotatable mounting disk structure and an implementation method thereof.

### BACKGROUND

A down lamp is a lighting fixture that is embedded in a ceiling and emits light downwards. The down lamp has a compact structure, is convenient to mount, and is widely used in home lighting and lighting and atmosphere creation in public places such as shopping malls and hotels. North America down lamps are used commonly, and their simple style and fast mounting methods have attracted the attention of many customers.

The mounting methods for the North American down lamps include mounting with a J-box, drum-free mounting, and mounting with an iron drum. The most common mounting method is mounting with a four-inch iron drum and a six-inch iron drum. In recent years, light-emitting diode (LED) down lamps integrated with two or three mounting methods have appeared in the market, which have the following drawbacks:
1. This LED down lamp is not simultaneously applied to both the four-inch iron drum and the six-inch iron drum.
2. A mounting disk of a J-BOX and a lamp body are mounted by using elastic sheets. This occupies the space of the J-BOX. Especially, a small-sized BOX has an extremely small wiring space, which may press a lamp and cause the lamp to not be completely sucked to a ceiling.
3. Accessories for mounting with an iron drum or new mounting are directly locked onto a lamp body, and a mounting disk needs to be discarded, resulting in waste. This does not comply with the environmental protection concept.

### SUMMARY

The present disclosure aims to provide a four-in-one down lamp with a rotatable mounting disk structure, so as to solve the problems mentioned in the background. The four-in-one down lamp with a rotatable mounting disk structure according to the present disclosure has the characteristics of satisfying four common mounting scenarios of a North American down lamp and greatly reducing the stocking pressure of a client.

The present disclosure further aims to provide an implementation method of a four-in-one down lamp with a rotatable mounting disk.

In order to achieve the above objective, the present disclosure provides the following technical solutions: A four-in-one down lamp with a rotatable mounting disk structure includes a lamp body and a mounting disk, wherein the lamp body includes an outer shell; a light source plate is arranged inside the outer shell; a diffusion cover is connected below the outer shell; a driving plate is mounted in a middle position of an upper surface of the outer shell; a driving shell located outside the driving plate is mounted on the upper surface of the outer shell; a concave cavity is arranged on the upper surface of the outer shell; a side wall of the concave cavity is connected to two symmetrically arranged fastening edges; two steps corresponding to the fastening edges are connected to a periphery of the mounting disk; the mounting disk is formed with screw holes and positioning slots which are configured to be connected to a mounting member.

Further, in order to avoid fall off of the lamp body caused by unintentional rotation of the lamp body after the lamp body is connected to the mounting disk, the steps are provided with limiting bulges, and limiting slots corresponding to the limiting bulges are arranged on the fastening edges.

In order to limit the rotation of the lamp body and facilitate fast rotating the lamp body to a mounting position, one end of each fastening edge is connected to a limiting block.

Further, the positioning slots include a first positioning slot and a second positioning slot.

Further, in order to satisfy the four common mounting scenarios of a North American down lamp, the mounting member is a butterfly elastic sheet, a V-shaped spring, or a power box component.

Further, in order to achieve mounting of the lamp body with a four-inch iron drum, the butterfly elastic sheet is provided with a first connecting block and a first positioning block which correspond to the screw hole and the second positioning slot.

Further, in order to achieve drum-free mounting of the lamp body, the power box component is provided with a third connecting block and a third positioning block which correspond to the screw hole and the first positioning slot.

Further, in order to achieve mounting of the lamp body with a six-inch iron drum, the V-shaped spring is provided with a second connecting block and a second positioning block which correspond to the screw hole and the second positioning slot; the four-in-one down lamp further includes a ferrule cooperating with a six-inch iron drum for mounting; and the ferrule is connected to several connecting buckles configured to be connected to the outer shell.

Further, in order to avoid direct friction between the lamp body and a ceiling and provide damping for the mounting of the lamp body, a mounting slot is arranged on the upper surface of the outer shell located on an outer side of the concave cavity, and an ethyl vinyl acetate (EVA) cotton ring is embedded into the mounting slot.

The present disclosure further provides an implementation method of the four-in-one down lamp with a rotatable mounting disk structure, including the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

Compared with the prior art, the present disclosure has the beneficial effects below:
1. The mounting disk and the lamp body of the present disclosure are connected to each other through cooperation between the fastening edges and the steps. The four-in-one down lamp is mounted rotatably, so that elastic sheets are eliminated, and spaces in a driving box and for wiring are not occupied.
2. According to the present disclosure, different mounting members are connected through screws on the mounting disk to satisfy the four common mounting scenarios of the North American down lamp, so that the stocking pressure of a client is greatly reduced, and the application range is large.
3. The mounting member of the present disclosure is directly mounted on the mounting disk. During mounting, the mounting disk does not need to be discarded. This will not cause a waste of resources. Furthermore, the lamp body does not need to be formed with a hole or a mounting structure, which ensures the integrity of the lamp body and makes the whole lamp have a good protection property.
4. The mounting slot is arranged on the upper surface of the outer shell of the present disclosure located on the outer side of the concave cavity, and the EVA cotton ring is embedded into the mounting slot. During the mounting of the lamp body, the EVA cotton ring can lean against the ceiling to avoid the direct friction between the lamp body and the ceiling and also provide damping for the mounting of the lamp body.

### BRIEF DESCRIPTION OF THE DRAWINGS

FIG. 1 is a schematic structural diagram of the present disclosure;

FIG. 2 is a schematic diagram of an exploded structure of a lamp body of the present disclosure;

FIG. 3 is a schematic structural diagram of a mounting disk of the present disclosure;

FIG. 4 is a schematic structural diagram of an outer shell of the present disclosure;

FIG. 5 and FIG. 6 are schematic structural diagrams of a butterfly elastic sheet of the present disclosure;

FIG. 7 is a schematic structural diagram of a V-shaped spring of the present disclosure;

FIG. 8 is a schematic structural diagram of a power box component of the present disclosure;

FIG. 9 is a schematic structural diagram of removing a top cover from the power box component of the present disclosure;

FIG. 10 is a schematic structural diagram of a ferrule of the present disclosure;

FIG. 11 is a schematic structural diagram of connection of a lamp body, a mounting disk, and a butterfly elastic sheet of the present disclosure;

FIG. 12 is a schematic structural diagram of connection of a lamp body, a mounting disk, and a power box component of the present disclosure; and

FIG. 13 is a schematic structural diagram of connection of a lamp body, a mounting disk, a V-shaped spring, and a ferrule of the present disclosure.

In the drawings: 1: lamp body; 2: mounting disk; 21: step; 22: limiting bulge; 23: first positioning slot; 24: screw hole; 25: second positioning slot; 3: diffusion cover; 4: light source plate; 5: outer shell; 51: concave cavity; 52: fastening edge; 53: limiting slot; 54: limiting block; 55: mounting slot; 6: EVA cotton ring; 7: driving plate; 8: driving shell; 9: butterfly elastic sheet; 91: first connecting block; 92: first positioning block; 10: V-shaped spring; 101: second connecting block; 102: second positioning block; 11: power box component; 111: third positioning block; 112: third connecting block; 12: ferrule; and 121: connecting buckle.

### DETAILED DESCRIPTION

The technical solutions in the embodiments of present disclosure are clearly and completely described below with reference to the accompanying drawings in the embodiments of present disclosure. Apparently, the described embodiments are merely some rather than all of the embodiments of present disclosure. All other embodiments obtained by a person of ordinary skill in the art based on the embodiments of present disclosure without making creative efforts shall fall within the protection scope of present disclosure.

### Embodiment 1

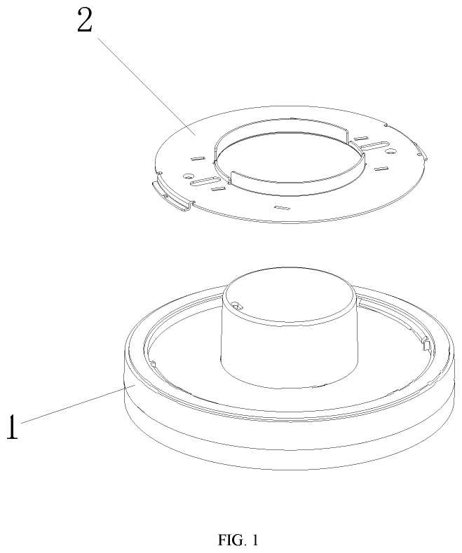

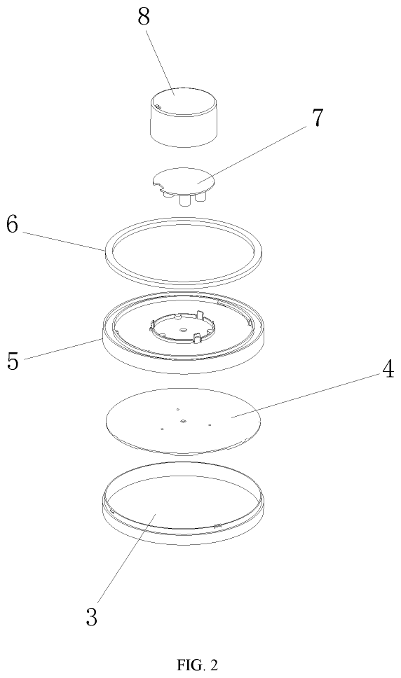

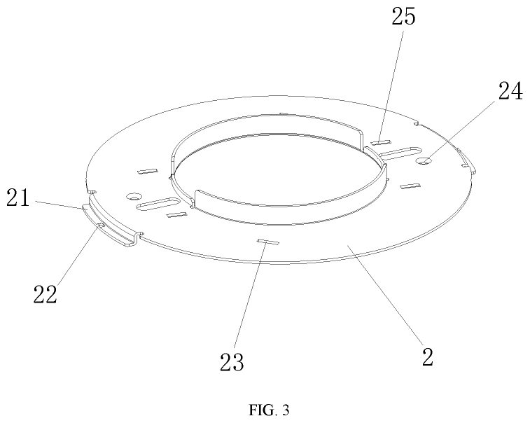

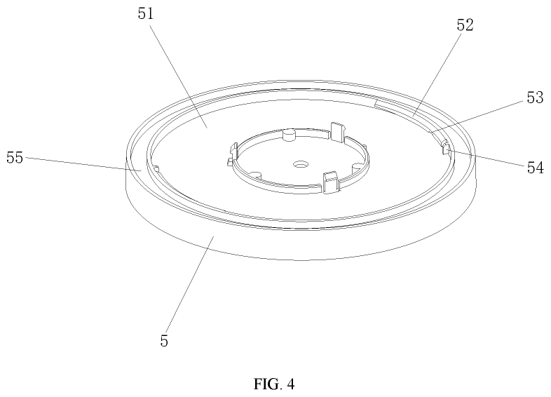

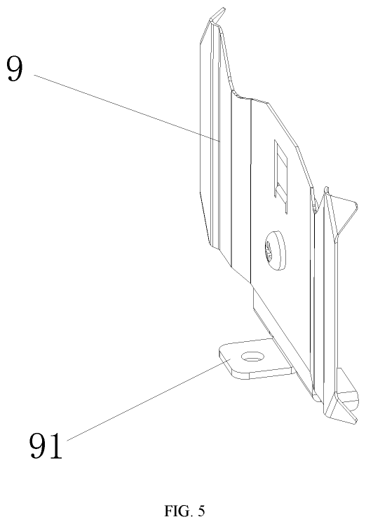

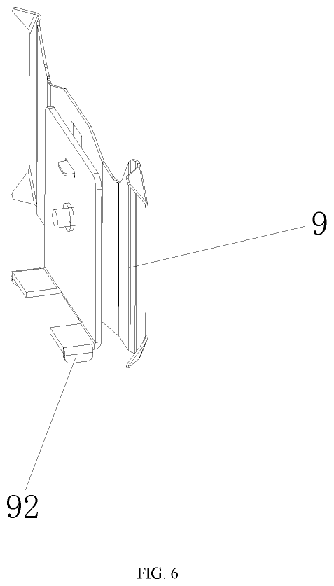

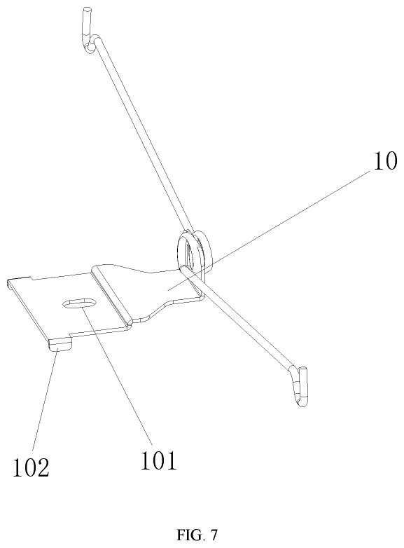

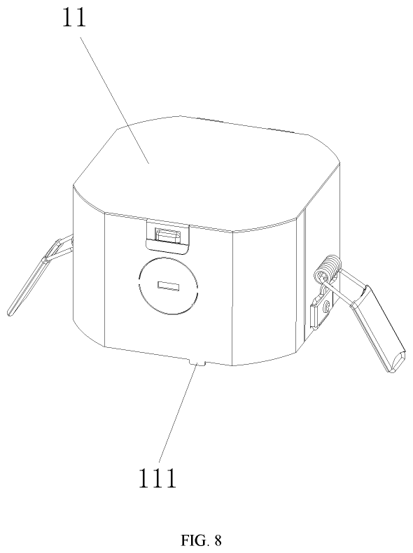

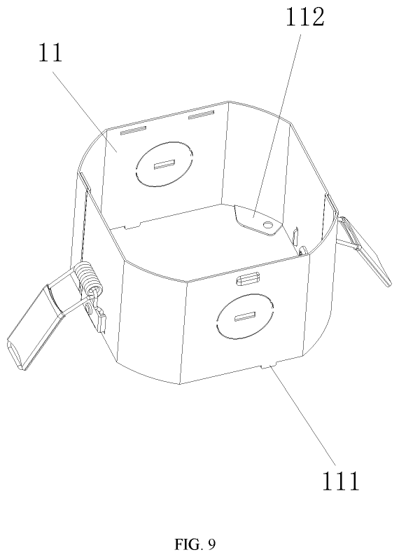

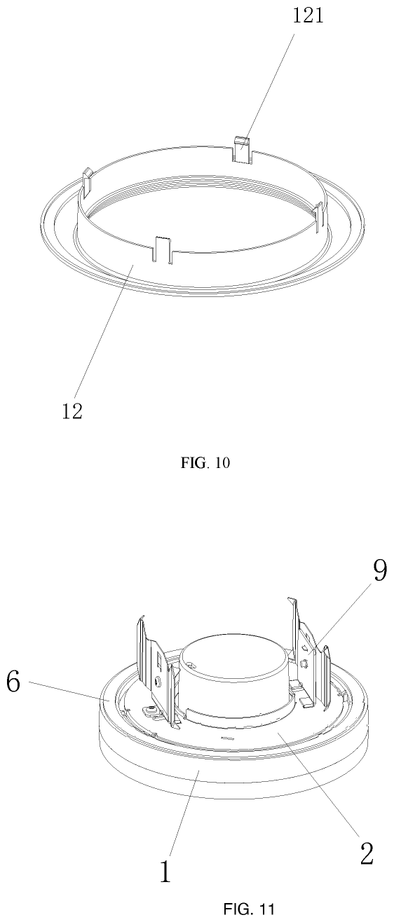

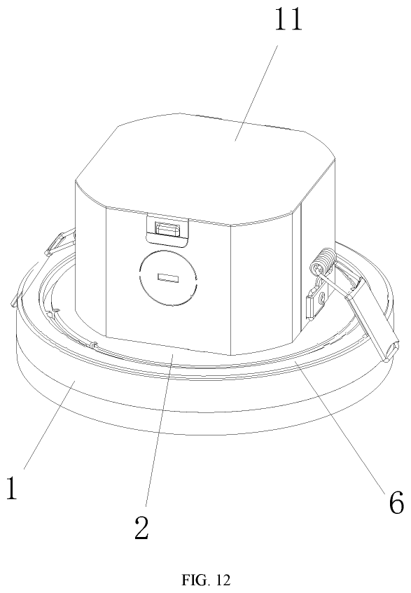

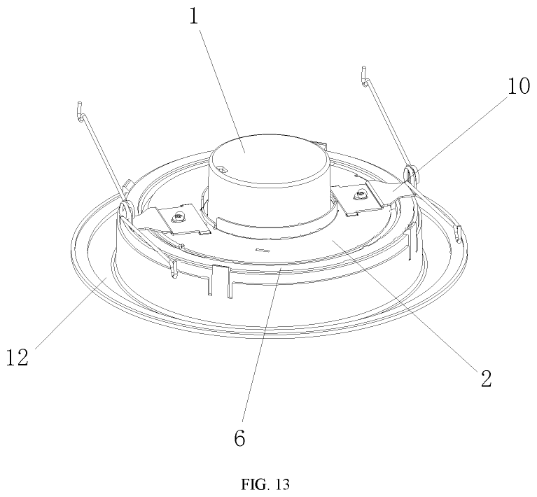

Referring to FIG. 1 to FIG. 13, the present disclosure provides the following technical solutions: A four-in-one down lamp with a rotatable mounting disk structure includes a lamp body 1 and a mounting disk 2, wherein the lamp body 1 includes an outer shell 5; a light source plate 4 is arranged inside the outer shell 5; a diffusion cover 3 is connected below the outer shell 5; a driving plate 7 is mounted in a middle position of an upper surface of the outer shell 5; a driving shell 8 located outside the driving plate 7 is mounted on the upper surface of the outer shell 5; a concave cavity 51 is arranged on the upper surface of the outer shell 5; a side wall of the concave cavity 51 is connected to two symmetrically arranged fastening edges 52; two steps 21 corresponding to the fastening edges 52 are connected to a periphery of the mounting disk 2; the steps 21 are molded by bending; and the mounting disk 2 is formed with screw holes 24 and positioning slots which are configured to be connected to a mounting member.

By the adoption of the above technical solution, the mounting disk 2 and the lamp body 1 of the present disclosure are connected to each other through cooperation between the fastening edges 52 and the steps 21. The four-in-one down lamp is mounted rotatably, so that elastic sheets are eliminated, and spaces in a driving box and for wiring are not occupied. The mounting disk 2 is connected to different mounting members through screws to satisfy four common mounting scenarios of a North American down lamp, so that the stocking pressure of a client is greatly reduced, and the application range is large. The mounting member of the present disclosure is directly mounted on the mounting disk 2. During mounting, the mounting disk 2 does not need to be discarded. This will not cause a waste of resources. Furthermore, the lamp body 1 does not need to be formed with a hole or a mounting structure, which ensures the integrity of the lamp body and makes the whole lamp have good protection property.

Specifically, the steps 21 are provided with limiting bulges 22; two side edges of the limiting bulges 22 are of arc structures; and limiting slots 53 corresponding to the limiting bulges 22 are arranged on the fastening edges 52.

By the adoption of the above technical solution, limitation is achieved through cooperation between the limiting bulges 22 and the limiting slots 53, which avoids fall off of the lamp body 1 caused by unintentional rotation of the lamp body 1 after the lamp body 1 is connected to the mounting disk 2.

Specifically, one end of each fastening edge 52 is connected to a limiting block 54.

By the adoption of the above technical solution, the rotation of the lamp body 1 is limited, and it is convenient for fast rotating the lamp body 1 to a mounting position.

Specifically, the positioning slots include a first positioning slot 23 and a second positioning slot 25.

### Embodiment 2

A difference between this embodiment and Embodiment 1 is as follows: Specifically, the mounting member is a butterfly elastic sheet 9. The butterfly elastic sheet 9 is provided with a first connecting block 91 and a first positioning block 92 which correspond to the screw hole 24 and the second positioning slot 25.

By the adoption of the above technical solution, mounting of the lamp body 1 with a four-inch iron drum is achieved.

### Embodiment 3

A difference between this embodiment and Embodiment 1 is as follows: Specifically, the mounting member is a power box component 11. The power box component 11 is provided with a third connecting block 112 and a third positioning block 111 which correspond to the screw hole 24 and the first positioning slot 23.

By the adoption of the above technical solution, drum-free mounting of the lamp body 1 is achieved.

### Embodiment 4

A difference between this embodiment and Embodiment 1 is as follows: Specifically, the mounting member is a V-shaped spring 10. The V-shaped spring 10 is provided with a second connecting block 101 and a second positioning block 102 which correspond to the screw hole 24 and the second positioning slot 25; the four-in-one down lamp further includes a ferrule 12 cooperating with a six-inch iron drum for mounting; and the ferrule 12 is connected to several connecting buckles 121 configured to be connected to the outer shell 5.

By the adoption of the above technical solution, mounting of the lamp body 1 with the six-inch iron drum is achieved.

### Embodiment 5

A difference between this embodiment and Embodiment 1 is as follows: Specifically, a mounting slot 55 is arranged on the upper surface of the outer shell 5 located on an outer side of the concave cavity 51, and an EVA cotton ring 6 is embedded into the mounting slot 55.

By the adoption of the above technical solution, during the mounting of the lamp body 1, the EVA cotton ring 6 can lean against the ceiling to avoid the direct friction between the lamp body 1 and the ceiling and also provide damping for the mounting of the lamp body 1.

### Embodiment 6

Further, the present disclosure provides an implementation method of the four-in-one down lamp with a rotatable mounting disk structure, including the following steps:
(I) mounting with a J-BOX: connecting the mounting disk 2 to the J-BOX through a screw, and connecting the lamp body 1 to the mounting disk 2 through the cooperation between the fastening edges 52 and the steps 21;
(II) mounting with a four-inch iron drum: inserting the first positioning block 92 of the butterfly elastic sheet 9 into the second positioning slot 25, connecting the first connecting block 91 to the mounting disk 2 through a screw, connecting the lamp body 1 to the mounting disk 2 through the cooperation between the fastening edges 52 and the steps 21, and then performing connection to the four-inch iron drum through the butterfly elastic sheet 9;
(III) mounting with a six-inch iron drum: inserting the second positioning block 102 of the V-shaped spring 10 into the second positioning slot 25, connecting the second connecting block 101 to the mounting disk 2 through a screw, connecting the lamp body 1 to the mounting disk 2 through the cooperation between the fastening edges 52 and the steps 21, then sleeving the outer shell 5 with the ferrule 12, connecting the ferrule 12 to the outer shell 5 through the connecting buckles 121, and performing connection to the six-inch iron drum through the V-shaped spring 10; and
(IV) drum-free mounting: inserting the third positioning block 111 of the power box component 11 into the first positioning slot 23, connecting the third connecting block 112 to the mounting disk 2 through a screw, connecting the lamp body 1 to the mounting disk 2 through the cooperation between the fastening edges 52 and the steps 21, and then mounting the power box component 11.

In summary, the mounting disk 2 and the lamp body 1 of the present disclosure are connected to each other through the cooperation between the fastening edges 52 and the steps 21. The four-in-one down lamp is mounted rotatably, so that elastic sheets are eliminated, and spaces in a driving box and for wiring are not occupied. According to the present disclosure, the mounting disk 2 is connected to different mounting members through screws to satisfy the four common mounting scenarios of the North American down lamp, so that the stocking pressure of a client is greatly reduced, and the application range is large. The mounting member of the present disclosure is directly mounted on the mounting disk 2. During mounting, the mounting disk 2 does not need to be discarded. This will not cause a waste of resources. Furthermore, the lamp body 1 does not need to be formed with a hole or a mounting structure, which ensures the integrity of the lamp body and makes the whole lamp have good protection property. The mounting slot 55 is arranged on the upper surface of the outer shell 5 of the present disclosure located on the outer side of the concave cavity 51, and the EVA cotton ring 6 is embedded into the mounting slot 55. During the mounting of the lamp body 1, the EVA cotton ring 6 can lean against the ceiling to avoid the direct friction between the lamp body 1 and the ceiling and also provide damping for the mounting of the lamp body 1.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

1. A four-in-one down lamp with a rotatable mounting disk structure, comprising a lamp body and a mounting disk, wherein the lamp body comprises an outer shell; a light source plate is arranged inside the outer shell; a diffusion cover is connected below the outer shell; a driving plate is mounted in a middle position of an upper surface of the outer shell; a driving shell located outside the driving plate is mounted on the upper surface of the outer shell; a concave cavity is arranged on the upper surface of the outer shell; a side wall of the concave cavity is connected to two symmetrically arranged fastening edges; two steps corresponding to the fastening edges are connected to a periphery of the mounting disk; and the mounting disk is formed with screw holes and positioning slots which are configured to be connected to a mounting member.

2. The four-in-one down lamp with a rotatable mounting disk structure according to claim 1, wherein the steps are provided with limiting bulges, and limiting slots corresponding to the limiting bulges are arranged on the fastening edges.

3. The four-in-one down lamp with a rotatable mounting disk structure according to claim 1, wherein one end of each fastening edge is connected to a limiting block.

4. The four-in-one down lamp with a rotatable mounting disk structure according to claim 1, wherein the positioning slots comprise a first positioning slot and a second positioning slot.

5. The four-in-one down lamp with a rotatable mounting disk structure according to claim 4, wherein the mounting member is a butterfly elastic sheet, a V-shaped spring, or a power box component.

6. The four-in-one down lamp with a rotatable mounting disk structure according to claim 5, wherein the butterfly elastic sheet is provided with a first connecting block and a first positioning block which correspond to the screw hole and the second positioning slot.

7. The four-in-one down lamp with a rotatable mounting disk structure according to claim 5, wherein the power box component is provided with a third connecting block and a third positioning block which correspond to the screw hole and the first positioning slot.

8. The four-in-one down lamp with a rotatable mounting disk structure according to claim 5, wherein the V-shaped spring is provided with a second connecting block and a second positioning block which correspond to the screw hole and the second positioning slot; the four-in-one down lamp further comprises a ferrule cooperating with a six-inch iron drum for mounting; and the ferrule is connected to several connecting buckles configured to be connected to the outer shell.

9. The four-in-one down lamp with a rotatable mounting disk structure according to claim 1, wherein a mounting slot is arranged on the upper surface of the outer shell located on an outer side of the concave cavity, and an ethyl vinyl acetate (EVA) cotton ring is embedded into the mounting slot.

10. An implementation method of the four-in-one down lamp with a rotatable mounting disk structure according to claim 1, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

11. An implementation method of the four-in-one down lamp with a rotatable mounting disk structure according to claim 2, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

12. An implementation method of the four-in-one down lamp with a rotatable mounting disk structure according to claim 3, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

13. An implementation method of the four-in-one down lamp with a rotatable mounting disk structure according to claim 4, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

14. An implementation method of the four-in-one down lamp with a rotatable mounting disk structure according to claim 5, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

15. An implementation method of the four-in-one down lamp with a rotatable mounting disk structure according to claim 6, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

16. An implementation method of the four-in-one down lamp with a rotatable mounting disk structure according to claim 7, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

17. An implementation method of the four-in-one down lamp with a rotatable mounting disk structure according to claim 8, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.

18. An implementation method of the four-in-one down lamp with a rotatable mounting disk structure according to claim 9, comprising the following steps:
(I) mounting with a J-BOX: connecting the mounting disk to the J-BOX through a screw, and connecting the lamp body to the mounting disk through the cooperation between the fastening edges and the steps;
(II) mounting with a four-inch iron drum: inserting the first positioning block of the butterfly elastic sheet into the second positioning slot, connecting the first connecting block to the mounting disk through a screw, connecting the lamp body to the mounting disk through the cooperation between the fastening edges and the steps, and then performing connection to the four-inch iron drum through the butterfly elastic sheet;
(III) mounting with a six-inch iron drum: inserting the second positioning block of the V-shaped spring into the second positioning slot, connecting the second connecting block to the mounting disk through a screw, connecting the lamp body to the mounting disk through the cooperation between the fastening edges and the steps, then sleeving the outer shell with the ferrule, connecting the ferrule to the outer shell through the connecting buckles, and performing connection to the six-inch iron drum through the V-shaped spring; and
(IV) drum-free mounting: inserting the third positioning block of the power box component into the first positioning slot, connecting the third connecting block to the mounting disk through a screw, connecting the lamp body to the mounting disk through the cooperation between the fastening edges and the steps, and then mounting the power box component.
